(19) United States
(12) Patent Application Publication
(10) Pub. No.: US 2022/0341786 A1
(43) Pub. Date: Oct. 27, 2022

(54) COLOR CHANGE IDENTIFICATON METHOD

(71) Applicant: Chiseki Yamaguchi, Saitama (JP)

(72) Inventor: Chiseki Yamaguchi, Saitama (JP)

(21) Appl. No.: 17/236,161

(22) Filed: Apr. 21, 2021

(51) Int. Cl. G01J 3/50

(52) U.S. Cl. CPC G01J 3/501

(57) ABSTRACT

To provide a color identification method capable of identifying a color-coded color region by a simple method. By using a method for measuring a distance to an object to be measured based on a principle of triangulation by using LED light, irradiating a position where a color of a color-coded plane changes with the LED light, receiving reflected light by a light receiving unit provided in a direction same as a direction where the color of the plane changes, and comparing an output signal from the light receiving unit at that time with an output signal obtained from the light receiving unit when a position where a color does not change is irradiated with the LED light, it is possible to identify a color change position of the color-coded plane.

### FIELD OF THE INVENTION

The present invention relates to a color change identification method for identifying a color change position of a plane color-coded by different colors.

### BACKGROUND

From conventional automatic transportation vehicles in factories, etc. to automatic driving of automobiles or unmanned aerial vehicles such as a drone in recent years, automatization of movement, transportation, etc., is rapidly progressing. In this case, it is designed to detect information related to an object or an operation from not only a close distance but also a distant distance, and to cope with subsequent operation control and various processes based on the information.

Regarding detection of the information related to the object or the operation, a detection method by using light, sound waves, or radio waves with sensors, and a detection method using a camera are put into practical use.

Regarding a detection method by using light, for example, a technical report “What is a sensor?” of Keyence Corporation introduces the detection method by using “light” as a photoelectric sensor, and introduces classification in detail according to a detection method. The outline of the photoelectric sensor is also described in detail in the technical description of the technical guide of OMRON Corporation.

The photoelectric sensor includes a light emitting unit and a light receiving unit, converts reflected light or transmitted light from an object to be detected into an electrical signal and outputs the electrical signal, and can detect presence or absence of the object to be detected, measure a distance to the object to be detected, and determine a color of the object to be detected. Regarding the detection of the presence or absence of the detection object, the presence of the object to be detected is detected according to blocking of light. The distance to the object to be detected is measured by detecting a difference in an angle of the reflected light, or a time until the light returns from the object to be detected. Furthermore, it is possible to determine a color by utilizing the fact that an amount of reflected light differs depending on the color of the object to be detected.

A laser range finder (LIDAR) that measures a distance to an object to be detected, in particular, an obstacle by irradiating a wide range with laser light as light and leads to generation of a 3D model is used as a sensor of an automatic driving technique, and in particular, development examples in Honda Motor Co., Ltd. and Nissan Motor Co., Ltd. are known (see, for example, Non-Patent Literature 1 “Measurement and Control”, Society of Instrument and Control Engineers, Vol. 54, No. 11, 2015, p. 828-835).

As the detection method by using sound waves, similarly, the technical report “What is a sensor?” of Keyence Corporation introduces an ultrasonic sensor of a detection method by using “ultrasonic waves”, and the distance to the object to be detected can be measured by transmitting the ultrasonic wave from a sensor head, receiving the ultrasonic wave reflected from the object to be detected again by the sensor head, and measuring the time from transmission to reception by the ultrasonic sensor.

As the detection method by using radio waves, there is a millimeter wave radar (RADAR) using millimeter waves, i.e., radio waves in a 30 to 300 GHz band in which a wavelength is in units of mm, and because of features thereof, the millimeter wave radar is used for obstacle detection as a sensor of an autonomous driving technique. The millimeter wave radar is explained in, for example, the RF/microwave section of the technical square of Marubun Corporation.

In many of these methods, in particular, in a case where a device is moved along a guide line drawn in a specific color on a plane, that is, the device is moved by a so-called line trace, it is common practice to provide a photoelectric sensor in front of the device on the guide line side, determine the color based on a difference in reflectance between a color of a line portion from a smaller distance and a color of the other portion, and perform travel control on the device based on the above information. Regarding color determination, it is also conceivable to identify the color of the line portion and the color of the other portion by using a color sensor.

In the method using a camera, according to an image recognition technique by camera shooting, it is possible to identify not only an obstacle but also an object to be detected in more detail and to detect or determine the features thereof.

### SUMMARY

Most of the detection methods by using light, sound waves, and radio waves described above detect information related to a distance to an object to be detected and are used to detect a three-dimensional structure from a long distance and to detect an obstacle and the like during a movement in an automation technique of movement, transportation, etc. Therefore, the presence of an object can be detected even from a distance of several meters or more, and stable detection can be performed even when a color of an object to be detected is different. Therefore, it is effective to detect presence or absence of the object to be detected and a step, but in order to detect a difference in a region of an object to be detected by using these detection methods, the object to be detected is limited to an object to be detected in which a step is provided for each region.

Moreover, when a difference between a color of a line portion and the other portion is detected as in a case of a line trace, a method using a photoelectric sensor, a color sensor, or a camera that detects a difference in reflectance depending on the color of the object to be detected and determines the color is adopted.

Among these methods, in detection using the photoelectric sensor for determining a color based on the difference in reflectance, it is necessary to detect an amount of reflected light from the object to be detected while reducing the influence of disturbance light as much as possible, so that it is necessary to detect the amount of reflected light from a distance of about 10 cm or less, and the detection is limited to a small distance. Further, there is a characteristic that the detection is not stable, such as being easily influenced by a change in distance to the object to be detected and a change in surface state. In addition, in detection of a boundary having a curved line, it is necessary to arrange a plurality of photoelectric sensors, and it is necessary to mechanically and electrically adjust the arrangement and characteristics of the photoelectric sensors, capture a plurality of signals, design a determination algorithm, and execute processing thereof, and it is also necessary to secure an attachment space, and thereby, an increased size. In addition, an interval is generated in attachment of the plurality of sensors, and determination is performed based on a magnitude relation with a threshold value, so that information is discrete and continuous information cannot be obtained.

Next, according to a method by image recognition of an image shot by a camera, image information is continuously obtained from a long distance to a wide area, and the method by the image recognition has high functionality and high performance as a method for obtaining the image information by an image shooting method or various image processing. Therefore, it is possible to detect a color on a color-coded plane, but it is necessary to cope with hardware preparation, design optimization of an image processing analysis algorithm, management and storage of a large amount of image data, an increase in processing speed, etc., and there is also a problem in terms of cost.

In a detection method using a color sensor, when handling the sensor, it is necessary to finely set hue, brightness, and saturation, and to manage and process a plurality of detection data for one color, which is difficult to handle in practice and requires a large number of man-hours. Maintenance and management of characteristics of the color sensor is also more required as compared with other sensors.

The present invention has been made to solve such problems in conventional detection, and an object of the present invention is to provide a color change identification method capable of identifying a color region color-coded by different colors on a plane by a simple method.

In order to achieve the above object, an invention according to claim 1 is a color change identification method for obtaining information on a color change position of an object having a plane in which a first color and a second color different from the first color are continuously arranged, the method including: arranging a light emitting unit and a light receiving unit capable of measuring a distance to the object based on a principle of triangulation in a direction same as a color arrangement direction of the first color and the second color, in which the light emitting unit irradiates the object with light having a predetermined light diameter, and the light receiving unit includes a position detecting element that receives, in a predetermined region, reflected light having a light diameter and reflected by the object and outputs a signal capable of specifying a light amount barycentric position based on a distribution of a light amount of the reflected light received by the position detecting element; specifying the light amount barycentric position based on the signal output from the light receiving unit; and obtaining information on a color change position between the first color and the second color on a plane of the object based on the specified light amount barycentric position.

An invention according to claim 2 is the color change identification method according to claim 1, the method further including: comparing light amount barycentric positions which are obtained at different positions of the plane of the object and which are specified by output signals based on a distribution of a light amount of reflected light from the object in a predetermined region of the position detecting element of the light receiving unit; and identifying a color arrangement positional relation between the first color and the second color with respect to a color change of the first color and the second color on the plane of the object.

An invention according to claim 3 is the color change identification method according to claim 1 or 2, the method including: setting the light emitting unit and the light receiving unit as a set of units; arranging two sets of units having different arrangement orders of the light emitting unit and the light receiving unit in the direction same as the color arrangement direction of the first color and the second color of the plane of the object; specifying a light amount barycentric position from an output signal based on a distribution of a light amount of reflected light from the object in a predetermined region of a position detecting element of a light receiving unit of one unit of the two sets of units and specifying a light amount barycentric position from an output signal based on a distribution of a light amount of reflected light from the object in a predetermined region of a position detecting element of a light receiving unit of the other unit obtained simultaneously with the light receiving unit of the one unit; and obtaining information on a color change position between the first color and the second color on the plane of the object based on the specified light amount barycentric position obtained from the one unit and the specified light amount barycentric position obtained from the other unit.

An invention according to claim 4 is the color change identification method according to claim 3, the method including: obtaining a sum of the light amount barycentric position specified from the output signal based on the distribution of the light amount of the reflected light from the object in the predetermined region of the position detecting element of the light receiving unit of the one unit and the light amount barycentric position specified from the output signal based on the distribution of the light amount of the reflected light from the object in the predetermined region of the position detecting element of the light receiving unit of the other unit; and identifying a color of a color region of the plane of the object.

An invention according to claim 5 is the color change identification method according to claim 3 or 4, the method including: obtaining a difference between the light amount barycentric position specified from the output signal based on the distribution of the light amount of the reflected light from the object in the predetermined region of the position detecting element of the light receiving unit of the one unit and the light amount barycentric position specified from the output signal based on the distribution of the light amount of the reflected light from the object in the predetermined region of the position detecting element of the light receiving unit of the other unit; and identifying a color change position between the first color and the second color of the plane of the object.

An invention according to claim 6 is the color change identification method according to any one of claims 3 to 5, the method including: adjusting a magnitude of the output signal indicating the light amount barycentric position specified by the one unit and a magnitude of the output signal indicating the light amount barycentric position specified by the other unit separately; and obtaining information on the color change position between the first color and the second color of the plane of the object by using each of output signals after adjustment.

An invention according to claim 7 is the color change identification method according to any one of claims 1 to 6, in which the light emitting unit is an LED.

An effect of a first method for solving the problems described above is as follows. That is, with a method of measuring a distance to an object, it is possible to obtain information on a color change of a plane color-coded by different colors without changing the distance to the object.

An effect of a second method for solving the problems described above is as follows. That is, in addition to the effect of the first method for solving the problems, it is possible to identify a color arrangement positional relation of two colors with respect to a boundary between colors of a plane color-coded by different two colors.

An effect of a third method for solving the problems described above is as follows. That is, by using two sets in which a positional relation between the light receiving unit and the light emitting unit is changed, in a case of performing color change for a plurality of times, it is possible to eliminate a difference in detection characteristic at a boundary position of the color change caused by a color arrangement positional relation and to reduce a moving distance for detection, as compared with a case of detecting the boundary position of the color change by one set.

An effect of a fourth method for solving the problems described above is as follows. That is, by adding outputs of the two sets in which the positional relation between the light receiving unit and the light emitting unit is changed, it is possible to identify the color of the two different colors.

An effect of a fifth method for solving the problems described above is as follows. That is, by obtaining a difference between the outputs from the two sets in which the positional relation between the light receiving unit and the light emitting unit is changed, it is possible to determine the color arrangement positional relation of the two colors where the color changes with different values of positive and negative signs. Further, even if outputs for surfaces of the same color are different between one set and the other set due to replacement and attachment of parts or changes in detection characteristics, correction can be performed to correct the outputs to the same value.

An effect of a sixth method for solving the problems described above is as follows. That is, results of addition and difference of the output signals can be shown in the same graph, and as compared with a case where color identification is performed by using a result obtained by adding magnitudes of the output signals as it is and a result of obtaining the difference, the state of the color change can be seen in a list, the identification can be easily performed, and identification accuracy can be improved. In addition, the magnitudes of the output signals of one set and the other set should be the same, but even if there is a difference in magnitudes of the output signals due to a difference, a change, etc. in attachment of a part or detection characteristics of an unit, it is possible to grasp the difference before performing the color identification, and it is possible to perform more accurate and stable color identification.

An effect of a seventh method for solving the problems described above is as follows. That is, by using an LED light source having a light diameter, an irradiation region can be secured for an object, and when a portion of the object where a color changes is irradiated, a light amount of reflected light in a direction of the light receiving unit differs depending on arrangement of color-coded colors in the irradiation range. Further, since an emission wavelength range is limited, the influence of spectral sensitivity in the light receiving unit can be reduced.

### BRIEF DESCRIPTION OF THE DRAWINGS

FIG. 1 is a diagram showing a principle of triangulation;

FIG. 2 is a diagram illustrating an optical path of reflected light from an object;

FIG. 3 is a photograph of light from a light emitting unit;

FIG. 4 is a diagram illustrating a configuration of a first embodiment;

FIG. 5 is a diagram illustrating a measurement result according to the first embodiment;

FIG. 6 is a diagram illustrating a configuration of a second embodiment;

FIG. 7 is a diagram illustrating a measurement result according to the second embodiment;

FIG. 8 is a diagram showing a result obtained by a third embodiment;

FIG. 9 is a diagram illustrating a measurement result according to a fourth embodiment;

FIG. 10 is a diagram showing a result obtained by a fifth embodiment;

FIG. 11 provides experimental results at a distance of 30 cm; and

FIG. 12 provides a distance characteristic diagram of the above infrared distance measuring sensor.

### DETAILED DESCRIPTION

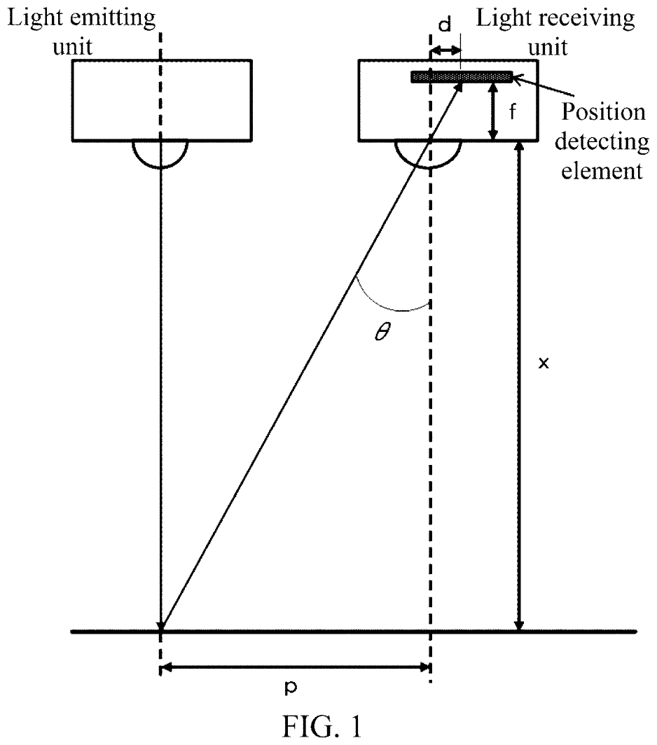

In a distance measurement according to the principle of triangulation, as shown in FIG. 1, when reflected light that is obtained by emitting light from a light emitting unit to hit an object and return is received by a light receiving unit, an incident angle θ to the light receiving unit changes according to a distance x to the object, so that d with respect to a position detecting element that detects information of a position where the light hits the light receiving unit changes, and the distance is obtained according to x=(p·f)/d.

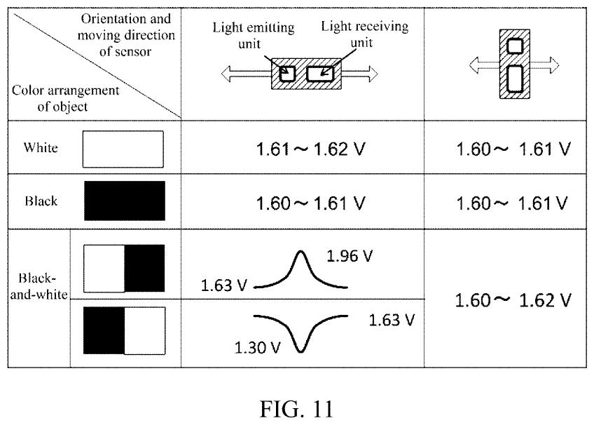

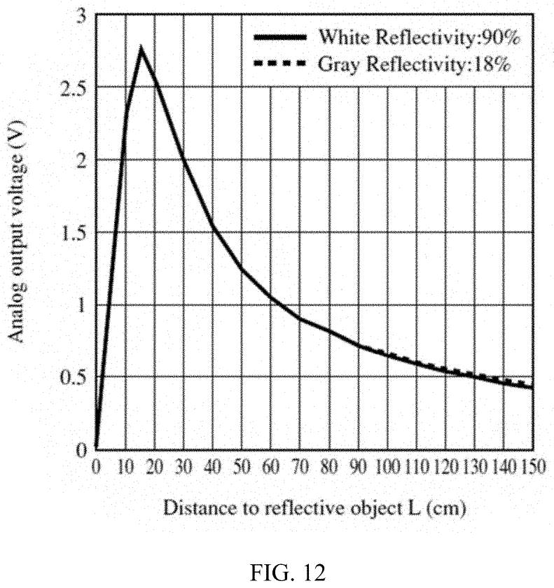

Based on the principle of triangulation, an experiment has been conducted to measure output voltages of a black object and a white object arranged at a constant distance by using an infrared distance measuring sensor in which a light emitting unit and a light receiving unit whose output voltage changes depending on the distance x to the object are integrally formed. An experiment has been conducted at a supply voltage of 4.5 VDC in a room temperature by using an infrared distance measuring module GP2Y0A02YK manufactured by Sharp Corporation as the infrared distance measuring sensor. A copy paper is used as the object, a solid black portion output by a monochrome copying machine is used as the black object, and a half of the paper is output as it is and is used as the white object. The object is placed on a desk, and the light emitting unit and the light receiving unit of the infrared distance measuring sensor are arranged so as to face downward in parallel with the same distance as the object. An experimental result at a distance of 30 cm is shown in FIG. 11. Further, a distance characteristic diagram of the above infrared distance measuring sensor is shown in FIG. 12.

For white and black objects, output voltages are the same regardless of an orientation of a sensor. However, for a black-and-white object color-coded with white and black, when the light emitting unit and the light receiving unit are arranged in the direction same as a color-coded direction, the result is different from an output voltage in a case of a single color of white or black. Further, when color arrangement positions of white and black in the black-and-white object are reversed, the result is also different. Furthermore, in an arrangement direction of the light emitting unit and the light receiving unit where the output voltage changes, when the sensor is moved in the color-coded direction, a change having a peak in the output voltage appears as the sensor passes over a position where the color changes. Moreover, as shown in the right column of FIG. 11, when the sensor is moved as indicated by an arrow in such a manner that the arrangement direction of the light emitting unit and the light receiving unit is perpendicular to the color-coded direction, there is no change in the output voltage of the sensor.

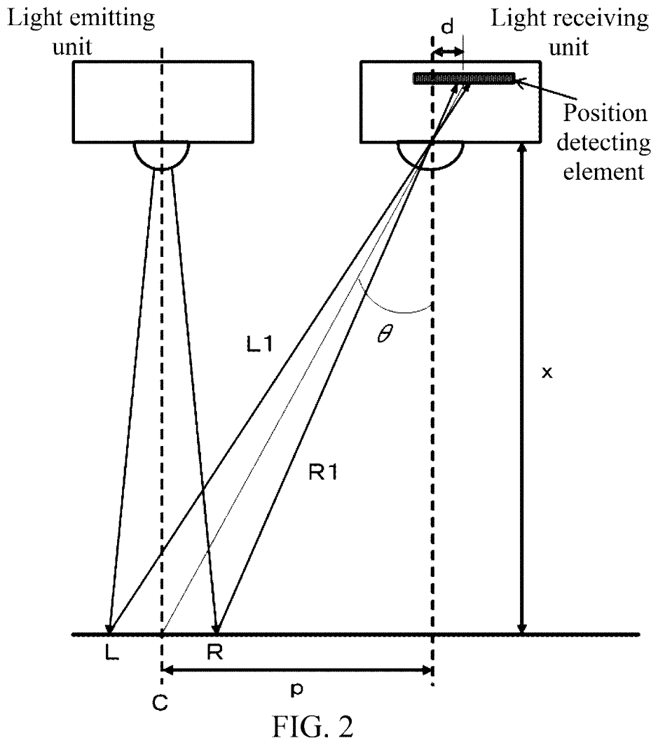

Factors of occurrence of such a phenomenon are considered as follows and will be described with reference to FIG. 2.

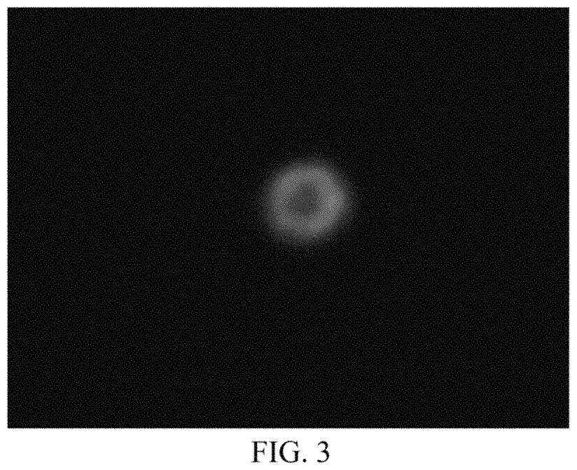

In FIG. 1, the light emitted from the light emitting unit is indicated by a line, but in a case where a light source of the light emitting unit is a light emitting diode element (LED), the light has a light diameter. FIG. 3 is a photograph of the light emitted from the light emitting unit, and it can be seen that the light has a ring-shaped light emission distribution in which light emission intensity is high in a vicinity of an outer periphery of a circular shape.

As a result, circular light having a light amount distribution inside hits the object, and as shown in FIG. 2, the reflected light from a position L of the object is incident on the light receiving unit in an optical path such as L1, and the reflected light from a position R of the object is incident on the light receiving unit in an optical path such as R1. Accordingly, the reflected light from the object hits the position detecting element in the light receiving unit with a light amount distribution in a vicinity of d shown in FIG. 1.

Based on characteristics of the position detecting element, information obtained from the position detecting element is a light amount barycentric position of entire light hitting the element, so that if the surface of the object is a single color such as a white color or a black color, there is no difference in the light amount barycentric position obtained from the position detecting element even if there is a difference in amount of light reaching the position detecting element due to a difference in reflectance depending on the color. Therefore, as can be seen from the experimental result of FIG. 11, the same output voltage is obtained for white and black. The above matter can be confirmed by the experimental result shown in FIG. 11.

However, when the color on the surface is different between an L side and an R side, since the reflectance is different, the light amount distribution of the position detecting element in the vicinity of d is different from that in a case of the single color, and therefore the light amount barycentric position is also different from a position of the single color.

As shown in FIG. 12, the infrared distance measuring sensor used in this experiment has a characteristic that the output voltage becomes lower as the distance becomes longer in a range of 20 cm to 150 cm, and when the distance x becomes shorter, the output voltage becomes higher as the incident angle θ becomes larger and d becomes larger. When white is present on the L side and black is present on the R side in FIG. 2, since the reflectance on the L side is larger, the light hits the position detecting element in a light amount distribution in which the light amount is larger on an outer side of d and the light amount is smaller on an inner side of d in FIG. 2. The light amount barycentric position at this time is a position where d is longer than that for the position in the case of the single color, and the output voltage is higher than that in the case of the single color. It can be said that this is the reason why the output voltage increases in a pattern of white on the left and black on the right in FIG. 11.

On the contrary, when black is present on the L side and white is present on the R side, since the reflectance on the R side is larger, the light hits the position detecting element in a light amount distribution in which the light amount is larger on an inner side of d and the light amount is smaller on an outer side of d in FIG. 2. Therefore, the light amount barycentric position is a position where d is shorter than that for the position in the case of the single color, and the output voltage is lower than that in the case of the single color. It can be said that this is the reason why the output voltage decreases in a pattern of black on the left and white on the right in FIG. 11.

Based on such characteristics, it can be described that the output voltage changes as a result of the color arrangement positional relation between black and white and the position of the color change in a range from L to R on the surface of the object hit by the light from the light emitting unit. This corresponds to the experimental result shown in FIG. 11 that in the arrangement direction of the light emitting unit and the light receiving unit where the output voltage changes, when the sensor is moved in the color-coded direction, the change having the peak in the output voltage appears as the sensor passes over the position where the color changes.

### First Embodiment

Next, an embodiment will be described.

In the present embodiment, with respect to an object on which a black region having a width of 40 mm is output and formed on a copy paper, a color change from white to black or from black to white is detected from a distance of 30 cm.

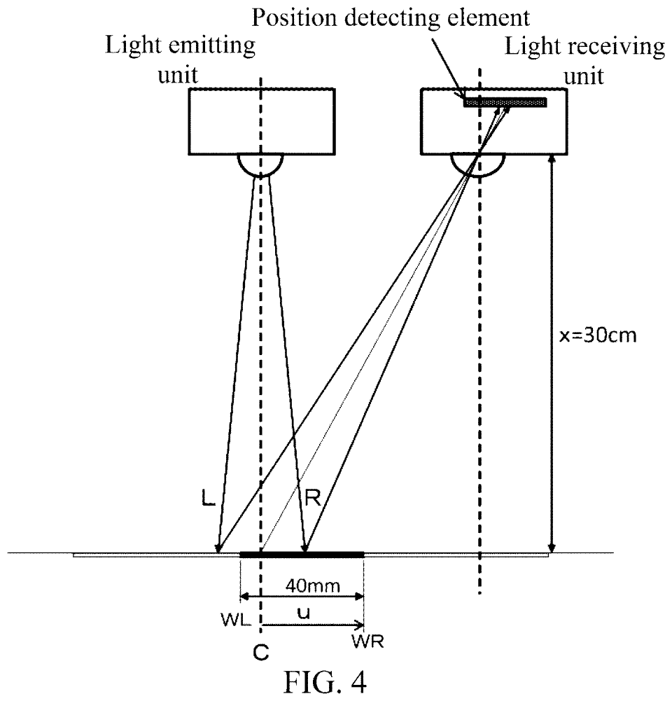

FIG. 4 shows a state of this experiment.

An infrared distance measuring sensor in which a light emitting unit and a light receiving unit are arranged in the direction same as a color-coded direction is fixed on a desk at a height of 30 cm, and a change in output voltage is measured while moving the copy paper, which is placed on the desk and on which the black region having a width of 40 mm, is output in a color change direction. A distance between a right end WR of the black region having a width of 40 mm and C immediately below the light emitting unit is defined as u, a right side in FIG. 4 is defined as plus, and the output voltage is measured and recorded at an interval of 5 mm between −30 mm and +70 mm.

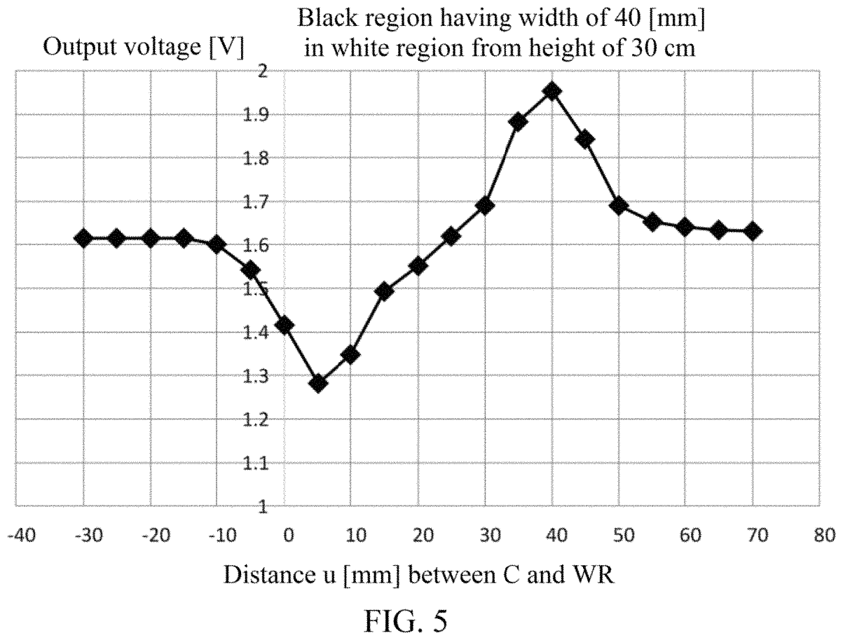

A result is shown in FIG. 5.

The output voltage changes with a change of u. An output voltage change is shown in which the output voltage is convex downward at a position where u is 5 mm and is convex upward at a position where u is 40 mm. From FIG. 4, when u is 0 mm, a region from C to the L side is black and a region from C to the R side is white, and when u is 40 mm, a region from C to the L side is white and a region from C to the R side is black.

In the experimental result, the output voltage is the lowest when the WR of the black region having a width of 40 mm reaches 5 mm from the R side, whereas the output voltage is highest when the WL is at the position of C.

According to a light amount distribution of reflected light from an object, a sensitivity distribution of a position detecting element, etc., the output voltage change which is completely symmetrical on a side where the WR is detected and a side where the WL is detected is not shown, but by grasping the characteristic in advance, it is possible to detect positions of the WR and the WL based on a change of the output voltage from the sensor. In particular, the position of the WL coincides with an inflection point of the output voltage.

### Second Embodiment

Next, another embodiment will be described.

In the first embodiment, an example using a set of a light emitting unit and a light receiving unit is shown. The set of the light emitting unit and the light receiving unit can also detect a color-coded color change position from the output voltage thereof, and the position of the WL can be detected when the output voltage rises to be the highest. However, position detection of the WR is different from a case where the change in output voltage is the lowest, which is considered to be also caused by an operation characteristic distribution of a sensor used, and a deviation occurs. Further, when a width from no color change to a next color change, that is, a length from the WL to the WR is long, in a case of one set, the light emitting unit and the light receiving unit have to move integrally over the entire width.

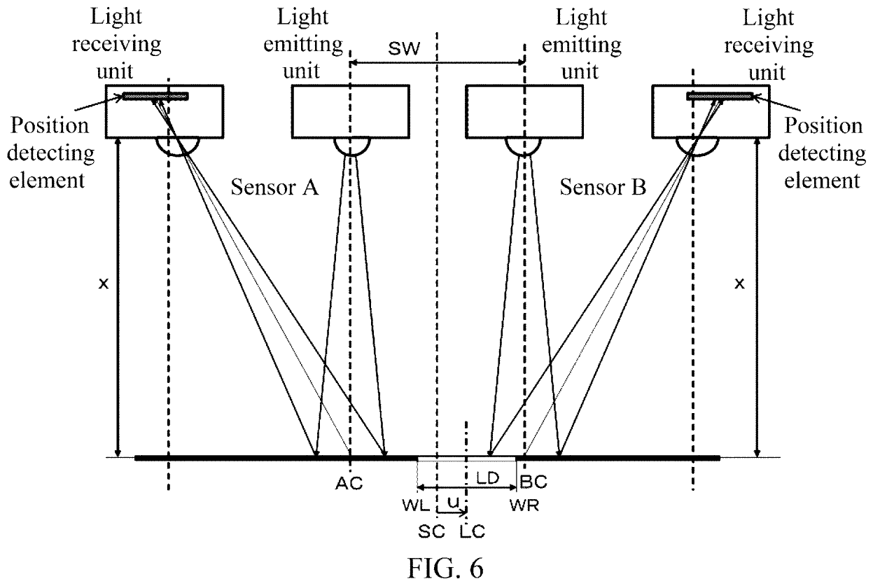

Therefore, in the second embodiment, another set of the light emitting unit and the light receiving unit is separately prepared and is arranged as shown in FIG. 6 for detection in which an arrangement positional relation between the light emitting unit and the light receiving unit that the L side is white and the R side is black with respect to C where the color change position can be accurately detected in the first embodiment is switched reversed the light emitting unit and the light receiving unit. In FIG. 6, the infrared distance measuring sensor used in the first embodiment is prepared for two, and the two sensors are arranged at the same distance from the object such that the arrangement positional relation of the light emitting unit and the light receiving unit with respect to the object is reversed. An interval SW between the light emitting units is set to 40 mm, a copy paper in which a white region having a width of 20 mm is formed in an entire black region is used as the object, the object is placed on a desk, and a color change from white to black or from black to white is detected from a height of 30 cm. As in the first embodiment, the two sensors are fixed, and changes in output voltages from the two sensors are measured while moving the object. A center between the two light emitting units is defined as SC, a center of the white region having a width of 20 mm is defined as LC, a position where the color changes to black on the left side of the white region is defined as WL, a position where the color changes to black on the right side of the white region is defined as WR, a distance between SC and LC is defined as u, a right side in FIG. 6 is defined as plus, and the output voltages are recorded while changing u between −50 mm and +50 mm at an interval of 5 mm. The set of a light emitting unit and a light receiving unit on the left side of FIG. 6 is referred to as a sensor A, and the set on the right side is referred to as a sensor B.

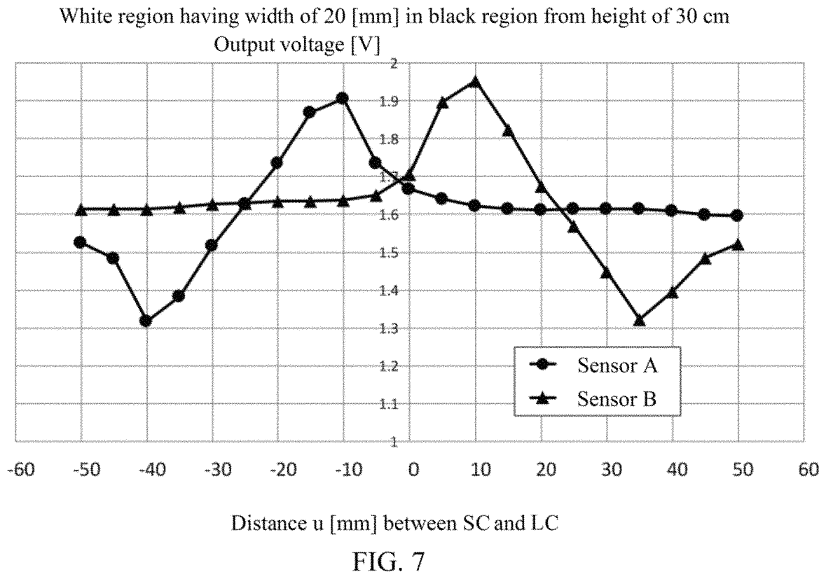

A result is shown in FIG. 7.

In the sensor A, when u is −10 mm, that is, when the WL is located at AC below the center of the light emitting unit of the sensor A, the output voltage is the highest. Further, in the sensor B, when u is 10 mm, that is, when the WR is located at BC below the center of the light emitting unit of the sensor B, the output voltage is the highest.

In this way, by using two sets in which the arrangement positional relation between the light emitting unit and the light receiving unit is switched, the positions of the color change from black to white and the color change from white to black can be detected more accurately according to the output signals from the respective light receiving units.

### Third Embodiment

According to the second embodiment, the position of the color change with respect to the white region in the black region can be accurately detected with the WL and the WR on left and right sides of the white region.

As can be seen from the experimental results shown in the first embodiment and the second embodiment, when the position of the color change is detected, the output voltage indicates a convex type output change having a peak. This means that even when there is no output voltage having a peak, that is, even when the position of the color change is not detected, it is presented based on a state of the output change that the position of the color change is present in the vicinity thereof. Further, a distance to the boundary of the color change can be estimated from a change in output voltage.

Referring to FIG. 5, it can be seen that, with respect to a position where u indicating a peak voltage is 40 mm when the boundary of the color change is detected in this experiment, for example, when the output voltage is 1.8 V, a position near 33 mm or 47 mm is detected.

Referring to FIG. 7, although there is a slight difference between the sensor A and the sensor B, when the output voltage of the sensor A is 1.8 V, it can be detected that the WL is near the AC and near 2 mm on the R side or 8 mm on the L side of the AC, and when the output voltage of the sensor B is 1.8 V, it can be detected that the WR is near the BC and near 7 mm on the L side or 6 mm on the R side of the BC.

Therefore, a next embodiment will be described.

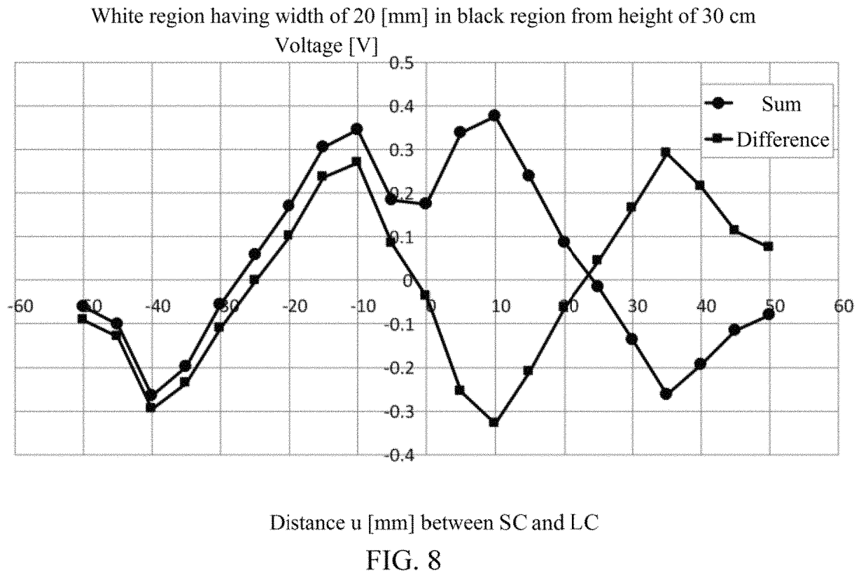

FIG. 8 shows a difference and a sum of the output voltages of the sensor A and the sensor B in FIG. 7 obtained in the experiment of FIG. 6. In this figure, in order to show the difference and the sum in the same graph, calculation is performed by using a value obtained by subtracting 1.6 V from a value of the output voltage of each of the sensor A and the sensor B. Accordingly, the sum is (output voltage value of sensor A−1.6)+(output voltage value of sensor B−1.6), and the difference is (output voltage value of sensor A−1.6)−(output voltage value of sensor B−1.6).

As a result, when the sum is 0.1 V or more, it can be determined that a position of SC in FIG. 6 is in the white region or in the vicinity of the white region, and when the sum is less than 0.1 V, it can be clearly determined that the position is in the black region. This indicates that the detection that cannot be obtained by a set of a light emitting unit and a light receiving unit, that is, by only the sensor A or only the sensor B, is possible.

This also indicates that when the sum is 0.1 V or more and the difference is about 0.15 V, it can be detected that the WL is near the AC, and when the sum is 0.1 V or more and the difference is about −0.2 V, it can be detected that the WR is near the BC.

In a case of detection on a WL side and detection on a WR side, a difference value is different regarding positive and negative signs, and as compared with a case where detection determination is performed by using the output voltage of each of the sensor A and the sensor B, since the detection determination can be performed in association with positive and negative signs, detection determination errors can be reduced, and determination can be made more easily.

Furthermore, when u is from −10 mm to 10 mm, a value of the difference changes substantially in a linear shape, and based on the value of the difference, it is also possible to estimate a position of the SC from the position of the color change in the white region. When the sum is 0.1 V or more and the difference is approximately 0 V, it can be seen that the SC is located at the center LC of the white region. This means that it is possible to detect the position of the SC in a line width in course detection of a line trace drawn with a constant width, and provides very useful information for operation control of the line trace.

In this way, by obtaining the sum and the difference and advancing determination processing of the detection using the values, it is possible not only to detect the position of the color change, but also to discriminate the color and obtain distance information from the position of the color change. Needless to say, it is possible to measure the distance to an object by triangulation.

### Fourth Embodiment

In the next embodiment, in FIG. 6, the interval SW between the two light emitting units is kept at 40 mm, x is set to 9 cm, and a copy paper in which a black region having a width of 55 mm is formed in the entire white region is used as an object.

Similar to the second embodiment, the two sensors are fixed, and the output voltages from the two sensors are measured while moving the object. The sensor is supplied with a DC voltage of 5.0 V, and measurement is performed while changing u from −70 mm to 70 mm at an interval of 5 mm.

An experiment is performed at room temperature.

Although the sensor used is the same as that described above, as shown in the above Ta, when a distance is 15 cm or less, the output voltage becomes higher as the distance becomes longer, and the sensor has a characteristic that the output voltage of the sensor shows a steep change in a linear relation with a distance change.

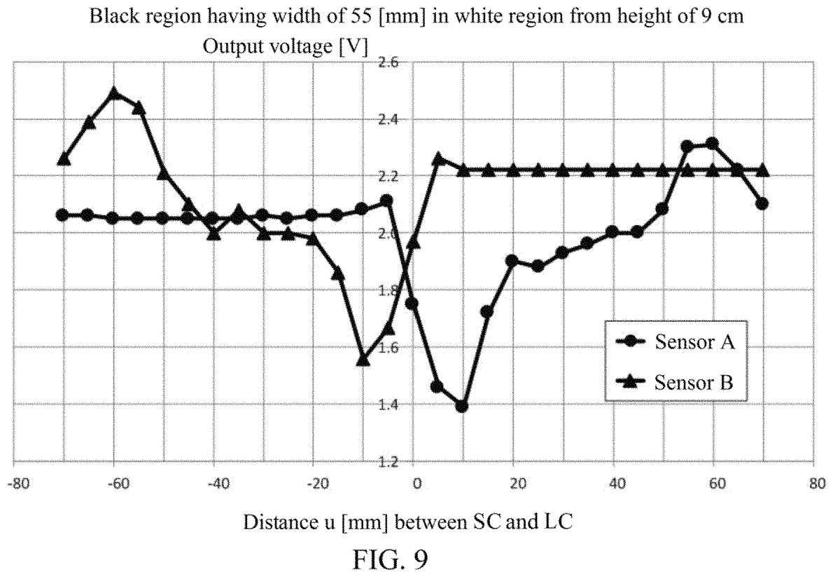

A result is shown in FIG. 9.

An output value for the entire white region is different by about 0.15 V between the sensor A and the sensor B. This is caused by the characteristic that the output voltage of the sensor changes sharply with respect to the distance change when a distance to the object is about 9 cm, appears because there is a difference in the distance to the object when both sensors are attached, and is a phenomenon that may occur practically.

Regarding a change state of the output voltage, in the sensor A, a downward convex change is shown in a vicinity of u=10 mm, and an upward convex change is shown in a vicinity of u=60 mm, and in the sensor B, a downward convex change is shown in a vicinity of −10 mm, and an upward convex change is shown in a vicinity of −60 mm.

The object is an object in which a black wide line is output in the entire white region, the LD is larger than the SW, and the distance and the output voltage have a positive relation, so that such a change state of the output voltage occurs.

When the SW is 40 mm and the LD is 55 mm, the change in the output voltage should be the most convex at a position where u is −7.5 mm or 7.5 mm, but the change appears at a position closer to −10 mm or 10 mm because measurement is performed at an interval of 5 mm.

If the change in output voltage is approximated by a curve, it can be seen that there is an inflection point around 7.5 mm in the sensor A and around −7.5 mm in the sensor B, so that it can be said that the position of the color change is correctly detected.

Further, in both the sensor A and the sensor B, a difference between u when the change in the output voltage is a downward convex inflection point and u when the change in the output voltage is an upward convex inflection point is close to a width of 55 mm of the black region drawn on the object, indicating that according to a detection method of the present invention, the position of the color change can be detected, and a length from the position of the color change to a next position of the color change can also be detected.

### Fifth Embodiment

Next, on the basis of this result, a difference and a sum of output voltages of the sensor A and the sensor B are obtained as in the third embodiment.

In calculation, an output value for the entire white region is different by about 0.15 V between the sensor A and the sensor B, and thus, in the calculation, values obtained by subtracting 2.05 V from the sensor A and 2.20 V from the sensor B are used.

Accordingly, the sum is (output voltage value of sensor A−2.05)+(output voltage value of sensor B−2.20), and the difference is (output voltage value of sensor A−2.05)−(output voltage value of sensor B−2.20).

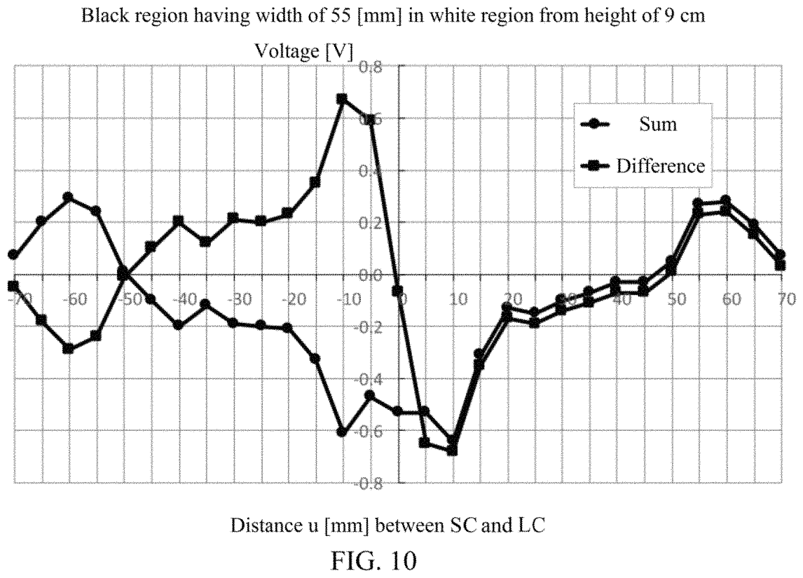

A result is shown in FIG. 10.

Accordingly, when the sum is lower than −0.4 V, it can be determined that both AC and BC in FIG. 6 are in the black region, or one of the AC and the BC is in the black region and the other is in a vicinity of a boundary between the black region and the white region, and when the sum is higher than −0.4 V, it can be determined that the AC and the BC in FIG. 6 are in other situations.

Further, when the sum is −0.4 V or less and the difference is about 0.5 V, it can be detected that the WR is near the BC, and when the sum is −0.4 V or less and the difference is about −0.5 V, it can be detected that the WL is near the AC.

As can be seen from the second embodiment and the fourth embodiment, even if a color arrangement positional relation between white and black is different and a distance to an object is different, the detection method of the present invention can be effectively realized.

The detection method according to the present invention is not limited to the detection method described in the embodiments. Those that realize the detection methods described in the claims are included without limitation.

In the embodiments described above, the embodiments are described with respect to a plane color-coded by white and black, but the present invention is not particularly limited thereto and can be applied to a case where the output from the light receiving unit is different from the output with respect to any one of the color-coded single colors at the color-coded color change position.

The problem in the detection method using one set of the light emitting unit and the light receiving unit is shown and the embodiment in which the other set of the light emitting unit and the light receiving unit in which the arrangement position is changed is shown, but the detection using only one set of the light emitting unit and the light receiving unit is not denied, and the characteristics thereof may be understood for use.

The embodiment in which the set of the light emitting portion and the light receiving portion and the set in which the arrangement position of the light emitting unit and the light receiving unit is changed are used together is shown, but in particular, without using the set in which the arrangement position of the light emitting unit and the light receiving unit is changed, arranging a plurality of sets in which arrangement positions of the light emitting unit and the light receiving unit are the same for detection is not denied and may be used.

In the embodiments, detection of an example in which a color changes in a horizontal direction of a figure is described, but the present invention is not particularly limited thereto.

Detection may be performed in a front-rear direction, a left-right and front-rear direction, and a plurality of directions including upper right, lower right, upper left, lower left, etc. Of course, the distance to the object is not limited.

Further, the attachment positional relationship between the object and the sensor is set such that the output voltage has a peak at 10 mm from the position of the color change in the second embodiment and at 7.5 mm from the position of the color change in the fourth embodiment, but this positional relationship may be changed freely.

Although the output voltage is used as the output from the light receiving unit, the output voltage is not limited thereto, and detection processing may be performed by using a digitally converted output value.

In the embodiments, an example is shown in which a value of the output voltage from the light receiving unit is used as it is to perform detection determination and calculation, but the output voltage may be amplified to advance detection processing.

The results obtained by the detection method of the present invention are more than described, but the detection method of the present invention may be utilized for various subsequent processing and control, and a system design and optimization processing for realizing a target can be advanced while repeating the detection and control.

### INDUSTRIAL APPLICABILITY

In the field of application of the present invention, line detection of a line trace is listed first. Not only when an existing line width is known, but also when a new line width to be provided in the future is different from the existing line width, it is possible to easily detect a line edge by only adjusting an arrangement interval between two sets of a light emitting unit and a light emitting unit. The arrangement interval can be freely set such that an output signal becomes strongest at the time of detecting the line edge, that is, a position of a color change, or a change can be freely made such that intensity of an output signal is increased at a position slightly separated from the line edge. Further, since the distance from the line edge, that is, an amount of positional deviation from the line edge is also known based on the output signal, it is also possible to cause line trace control to be performed according to a value thereof.

The detection method of the present invention can also be used for detection from the sky and detection in the sky, and can also be used as a detection method for movement guidance of a drone. Even if a distance to the ground changes, the distance can be measured, and even if a distance to a laid line, an installed cable, etc. changes, the distance can be continuously detected.

Next, in the present invention, even if the object is separated and the distance to the object is changed, target detection can be performed by grasping in advance a relation between the distance, a value of the output signal from the light receiving unit at a position where a color changes and a sum or a difference thereof, and a threshold value, so that the detection method of the present invention can be used to identify a marker or a guide plate from a long position. Most of markers and guide plates are drawn in different colors on a plane. When a sensor having the detection method of the present invention performs scanning, position information of the color change of a picture drawn in different colors is continuously obtained, and information indicated by the maker or the guide plate can be identified or discriminated by comparison with existing data. Since a distance to the marker or the guide plate can be measured at any time by triangulation, the distance can be detected without any problem even if the distance changes.

Even in an existing infrastructure, even in a situation where work is performed along a line drawn on a road, a railway rail, etc., the detection method of the present invention can be used to detect a position of the line or the rail and a deviation from the position from above.

The detection method of the present invention can also be mounted on a playground equipment, a special device, etc. in which an operation range is, for example, only inside a plane divided by colors, and can be a detection method for preventing running away or jumping out to an outside of a limited region.

As described above, the detection method of the present invention can be utilized in many industrial fields, has a degree of freedom relating to arrangement conditions for obtaining a desired detection result in accordance with an object at the time of utilization, and has a high utility value and enormous effects and effectiveness.

What is claimed is:

1. A color change identification method for obtaining information on a color change position of an object having a plane in which a first color and a second color different from the first color are continuously arranged, the method comprising:
arranging a light emitting unit and a light receiving unit capable of measuring a distance to the object based on a principle of triangulation in a direction same as a color arrangement direction of the first color and the second color, wherein
the light emitting unit irradiates the object with light having a predetermined light diameter, and
the light receiving unit includes a position detecting element that receives, in a predetermined region, reflected light having a light diameter and reflected by the object and outputs a signal capable of specifying a light amount barycentric position based on a distribution of a light amount of the reflected light received by the position detecting element;
specifying the light amount barycentric position based on the signal output from the light receiving unit; and
obtaining information on a color change position between the first color and the second color on a plane of the object based on the specified light amount barycentric position.

2. The color change identification method according to claim 1, further comprising:
comparing light amount barycentric positions which are obtained at different positions of the plane of the object and which are specified by output signals based on a distribution of a light amount of reflected light from the object in a predetermined region of the position detecting element of the light receiving unit; and
identifying a color arrangement positional relation between the first color and the second color with respect to a color change of the first color and the second color on the plane of the object.

3. The color change identification method according to claim 1, further comprising:
setting the light emitting unit and the light receiving unit as a set of units;
arranging two sets of units having different arrangement orders of the light emitting unit and the light receiving unit in the direction same as the color arrangement direction of the first color and the second color on the plane of the object;
specifying a light amount barycentric position from an output signal based on a distribution of a light amount of reflected light from the object in a predetermined region of a position detecting element of a light receiving unit of one unit of the two sets of units and specifying a light amount barycentric position from an output signal based on a distribution of a light amount of reflected light from the object in a predetermined region of a position detecting element of a light receiving unit of the other unit obtained simultaneously with the light receiving unit of the one unit; and
obtaining information on a color change position between the first color and the second color on the plane of the object based on the specified light amount barycentric position obtained from the one unit and the specified light amount barycentric position obtained from the other unit.

4. The color change identification method according to claim 3, further comprising:
obtaining a sum of the light amount barycentric position specified from the output signal based on the distribution of the light amount of the reflected light from the object in the predetermined region of the position detecting element of the light receiving unit of the one unit and the light amount barycentric position specified from the output signal based on the distribution of the light amount of the reflected light from the object in the predetermined region of the position detecting element of the light receiving unit of the other unit; and
identifying a color of a color region of the plane of the object.

5. The color change identification method according to claim 3, further comprising:
obtaining a difference between the light amount barycentric position specified from the output signal based on the distribution of the light amount of the reflected light from the object in the predetermined region of the position detecting element of the light receiving unit of the one unit and the light amount barycentric position specified from the output signal based on the distribution of the light amount of the reflected light from the object in the predetermined region of the position detecting element of the light receiving unit of the other unit; and
identifying a color change position between the first color and the second color of the plane of the object.

6. The color change identification method according to claim 3, further comprising:
adjusting a magnitude of the output signal indicating the light amount barycentric position specified by the one unit and a magnitude of the output signal indicating the light amount barycentric position specified by the other unit separately; and
obtaining information on the color change position between the first color and the second color of the plane of the object by using each of output signals after adjustment.

7. The color change identification method according to claim 1, wherein
the light emitting unit is an LED.
